(19) United States
(12) Patent Application Publication
(10) Pub. No.: US 2011/0032269 A1
(43) Pub. Date: Feb. 10, 2011

(54) Automatically Resizing Demosaicked Full-Color Images Using Edge-Orientation Maps Formed In The Demosaicking Process

(76) Inventors: Rastislav Lukac, North York (CA); Ryuichi Shiohara, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/536,254

(22) Filed: Aug. 5, 2009

(51) Int. Cl. G09G 5/00; G06K 9/32

(52) U.S. Cl. 345/606; 382/300

(57) ABSTRACT

Automatically resizing demosaicked full-color images using edge-orientation maps formed in the demosaicking process. In a first example embodiment, a method for automatic upsampling of a demosaicked image includes several acts. First, a demosaicked image and an edge-orientation map that was created during the creation of the demosaicked image are received. Next, pixels of the demosaicked image are filled into an upsampled image. Then, edge-orientation values of pixels of the edge-orientation map are filled into an upsampled edge-orientation map. Next, an interpolation direction is determined for each pixel in which upsampling of the demosaicked image should be performed using the upsampled edge-orientation map. Finally, missing pixels in the upsampled image are estimated by performing interpolation along the interpolation direction using available pixels surrounding each missing pixel location.

### THE FIELD OF THE INVENTION

The invention relates to digital image processing. More specifically, embodiments of the present invention relate to automatically resizing demosaicked full-color images using edge-orientation maps formed in the demosaicking process.

### BACKGROUND

A digital image is a representation of a two-dimensional analog image as a finite set of pixels. Digital images can be created by a variety of devices, such as digital cameras, scanners, and various other computing devices. Digital image processing is the use of computer algorithms to perform image processing on digital images. Image processing operations include color to grayscale conversion, color adjustment, intensity adjustment, scene analysis, object recognition, demosaicking, and resizing.

Demosaicking or color interpolation refers to a process of interpolating a full-color digital image from mosaic data received from an image sensor equipped with a color filter array (CFA) internal to many digital cameras. Resizing refers to a process of shrinking or enlarging the number of pixels in a digital image. Resizing is typically performed on a digital image after demosaicking using a spatial interpolation method. Spatial interpolation refers to the process of changing the spatial resolution of a digital image. Spatial interpolation can either result in the downsampling of a digital image by reducing the number of pixels representing the digital image, or in the upsampling of a digital image by increasing the number of pixels representing the digital image. A digital image can be downsampled in order to reduce the memory required to store and/or transmit the digital image or to print the digital image on small-format printers or photo printers, for example. A digital image can be upsampled in order to format the digital image for large-format printers or view the digital image on high-resolution displays, for example.

Current methods for resizing digital images are generally inefficient, as they are costly in terms of time and processing resources, and can result in relatively low image quality. A need exists therefore for methods for resizing digital camera images that are more efficient and less costly than current methods and that result in relatively high image quality.

### SUMMARY

In general, example embodiments relate to automatically resizing demosaicked full-color images using edge-orientation maps formed in the demosaicking process. Some example methods allow an image to be upsampled or downsampled along edges using one or more edge-orientation maps formed in the demosaicking process. Since the example methods allow for some integration of both demosaicking and image resizing while producing visually pleasing upsampled or downsampled full-color images, these example methods are an attractive solution for cost-effective imaging systems.

In a first example embodiment, a method for automatic upsampling of a demosaicked image includes several acts. First, a demosaicked image and an edge-orientation map that was created during the creation of the demosaicked image are received. Next, pixels of the demosaicked image are filled into an upsampled image. Then, edge-orientation values of pixels of the edge-orientation map are filled into an upsampled edge-orientation map. Next, an interpolation direction is determined for each pixel in which upsampling of the demosaicked image should be performed using the upsampled edge-orientation map. Finally, missing pixels in the upsampled image are estimated by performing interpolation along the interpolation direction using available pixels surrounding each missing pixel location.

In a second example embodiment, a method for automatic downsampling of a demosaicked image includes several acts. First, a demosaicked image and an edge-orientation map that was created during the creation of the demosaicked image are received. Next, a block of demosaicked pixels from the demosaicked image and a corresponding block of edge-orientation values from the edge-orientation map are selected based on the location of each pixel under consideration in a downsampled image and a downsampling factor. Then, the interpolation direction in which downsampling of the demosaicked image should be performed is determined using the value of the selected block of edge-orientation values. Next, weights associated with the demosaicked pixels located inside the block of demosaicked pixels are set according to the interpolation direction. Finally, pixels in the downsampled image are estimated by performing interpolation along the interpolation direction using demosaicked pixels located inside the block of demosaicked pixels and the weights associated with the demosaicked pixels located inside the block of demosaicked pixels.

In a third example embodiment, one or more computer-readable media have computer-readable instructions thereon which, when executed, implement the method for automatic upsampling of a demosaicked image discussed above in connection with the first example embodiment.

In a fourth example embodiment, one or more computer-readable media have computer-readable instructions thereon which, when executed, implement the method for automatic downsampling of a demosaicked image discussed above in connection with the second example embodiment.

In a fifth example embodiment, an image processing apparatus includes an electronic display, a processor in electronic communication with the electronic display, and one or more computer-readable media in electronic communication with the processor. The one or more computer-readable media have computer-readable instructions thereon which, when executed by the processor, cause the processor to perform the acts of the method for upsampling of a demosaicked image discussed above in connection with the first example embodiment, as well as perform the act of sending the upsampled image to the electronic display for presentation thereon.

In a sixth example embodiment, an image processing apparatus includes an electronic display, a processor in electronic communication with the electronic display, and one or more computer-readable media in electronic communication with the processor. The one or more computer-readable media have computer-readable instructions thereon which, when executed by the processor, cause the processor to perform the acts of the method for downsampling of a demosaicked image discussed above in connection with the second example embodiment, as well as perform the act of sending the downsampled image to the electronic display for presentation thereon.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further develop the above and other aspects of example embodiments of the invention, a more particular description of these examples will be rendered by reference to specific embodiments thereof which are disclosed in the appended drawings. It is appreciated that these drawings depict only example embodiments of the invention and are therefore not to be considered limiting of its scope. It is also appreciated that the drawings are diagrammatic and schematic representations of example embodiments of the invention, and are not limiting of the present invention. Example embodiments of the invention will be disclosed and explained with additional specificity and detail through the use of the accompanying drawings in which:

FIG. 1 schematically illustrates the configuration of a digital camera equipped with an image processing apparatus;

FIG. 2 is a conceptual view showing the structure of a color filter array and an image sensor included in the image processing apparatus of FIG. 1;

FIG. 3 is a flowchart of an example demosaicking and edge-orientation map creation method;

FIG. 4 is a flowchart of an example method for upsampling a demosaicked image;

FIGS. 5-7 disclose various aspects of the example method of FIG. 4;

FIG. 8 is a flowchart of an example method for downsampling a demosaicked image; and

FIG. 9 discloses various aspects of the example method of FIG. 8.

### DETAILED DESCRIPTION OF SOME EXAMPLE EMBODIMENTS

In the following detailed description of the embodiments, reference is made to the accompanying drawings that show, by way of illustration, specific embodiments of the invention. In the drawings, like numerals describe substantially similar components throughout the several views. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

In general, example embodiments relate to methods for upsampling and downsampling demosaicked full-color images using edge-orientation maps formed in the demosaicking process. These example methods allow an image to be upsampled or downsampled along edges using one or more edge-orientation maps formed in the demosaicking process. Since the example methods allow for some integration of both demosaicking and downsampling while producing visually pleasing upsampled or downsampled full-color images, these example methods are an attractive solution for cost-effective imaging systems.

### I. Example Environment

The example methods and variations thereof disclosed herein can be implemented using computer-readable media for carrying or having computer-executable instructions or data structures stored thereon. Such computer-readable media can be any available media that can be accessed by a processor of a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store program code in the form of computer-executable instructions or data structures and which can be accessed by a processor of a general purpose or special purpose computer. Combinations of the above should also be included within the scope of computer-readable media.

Computer-executable instructions comprise, for example, instructions and data which cause a processor of a general purpose computer or a special purpose computer to perform a certain function or group of functions. Although the subject matter is described herein in language specific to methodological acts, it is to be understood that the subject matter defined in the appended claims is not necessarily limited to the specific acts described herein. Rather, the specific acts described herein are disclosed as example forms of implementing the claims.

Examples of special purpose computers include image processing apparatuses such as digital cameras (an example of which includes, but is not limited to, the Epson R-D1 digital camera manufactured by Seiko Epson Corporation headquartered in Owa, Suwa, Nagano, Japan), digital camcorders, projectors, printers, scanners (examples of which include, but are not limited to, the Epson Perfection© V200, V300, V500, V700, 4490, and V750-M Pro, the Epson Expression© 10000XL, and the Epson GT-1500, GT-2500, GT-15000, GT-20000, and GT-30000, all manufactured by Seiko Epson Corporation), copiers, portable photo viewers (examples of which include, but are not limited to, the Epson P-3000 or P-5000 portable photo viewers manufactured by Seiko Epson Corporation), or portable movie players, or some combination thereof, such as a printer/scanner/copier combination (examples of which include, but are not limited to, the Epson Stylus Photo RX580, RX595, or RX680, the Epson Stylus CX4400, CX7400, CX8400, or CX9400Fax, and the Epson AcuLaser® CX11NF manufactured by Seiko Epson Corporation) or a digital camera/camcorder combination. An image processing apparatus may include automatic resizing capability, for example, to automatically upsample or downsample a demosaicked full-color image. For example, a digital camera with this automatic resizing capability may include one or more computer-readable media that implement the example methods disclosed herein, or a computer connected to the digital camera may include one or more computer-readable media that implement the example methods disclosed herein.

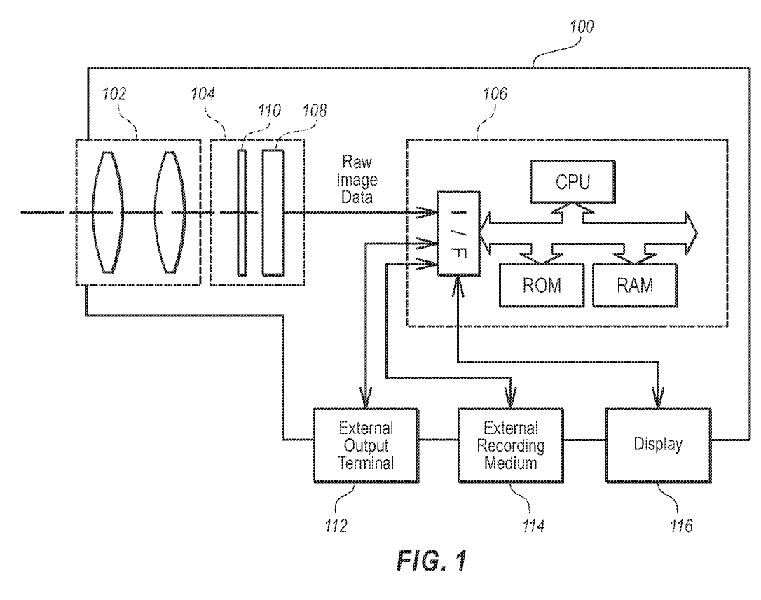

While any imaging apparatus could be used, for purposes of illustration an example embodiment will be described in connection with an example digital camera, a schematic representation of which is denoted at 100 in FIG. 1. As disclosed in FIG. 1, the digital camera 100 includes an optical system 102 that has a group of multiple lenses, an imaging assembly 104 that converts an image of a subject formed by the optical system 102 into electric signals, and the image processing apparatus 106 that receives the electric signals from the imaging assembly 104 and makes the received electric signals subjected to a predetermined series of image processing to generate color image data.

The imaging assembly 104 has an image sensor 108 with a two-dimensional arrangement of multiple fine imaging elements for converting the light intensities into electric signals. A color filter array 110 is provided before the image sensor 108 and has a mosaic arrangement of fine color filters of R (red), G (green), and B (blue). The arrangement of the R, G, and B color filters constituting the color filter array 110 will be described later in detail. The R color filters, the G color filters, and the B color filters are constructed to allow transmission, respectively, of light of different wavelengths in the visible spectrum. Therefore image sensor 108 captures image data having a mosaic arrangement of image parts responsive to the R light intensities, image parts responsive to the G light intensities, and image parts responsive to the B light intensities according to the mosaic arrangement of the R, G, and B color filters in the color filter array 110. Since each sensor cell acquires only one measurement corresponding to an R, G, or B component of a color, the full-color image has to be obtained from the acquired sensor data using a process known as demosaicking.

For example, the image processing apparatus 106 of the digital camera 100 can receive the image data of the mosaic arrangement from the imaging assembly 104 and perform demosaicking to generate color image data with settings of the R component, the G component, and the B component in the respective pixels. In the image processing apparatus 106 of the embodiment, a CPU, a ROM, a RAM, and a data input/output interface (I/F) are interconnected via a bus to enable mutual data transmission. The CPU performs a series of processing to generate the color image data according to a program of computer-readable instructions stored in the ROM or stored on other computer-readable media. The resulting color image data thus generated may be output to an external device via an external output terminal 112, may be output to an external recording medium 114, or may be output to a display 116. The display 116 can be any type of an electronic display including, but not limited to a visual display, an auditory display, or a tactile display. For example, the display 116 can be an electronic visual display such as a liquid crystal display (LCD).

The image data with the mosaic arrangement of the R, G, and B components captured by the image sensor 108 is used as source data, which is referred to by the image processing apparatus 106 to generate the color image data with the settings of the R, G, and B components in the respective pixels. The image data of the mosaic arrangement captured by the image sensor 108 is referred to herein as “raw image data”. This mosaic image is used as the input of the demosaicking process to generate a corresponding demosaicked full-color image.

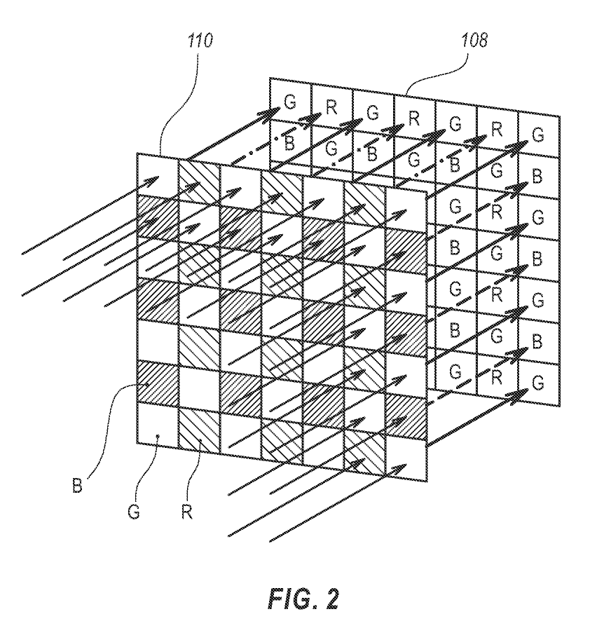

FIG. 2 is a conceptual view showing the structure of the color filter array 110 and the image sensor 108. As mentioned above, the image sensor 108 has the two-dimensional arrangement of fine imaging elements that output electric signals corresponding to the light intensities. In the illustrated example of FIG. 2, the fine imaging elements are arranged in a lattice pattern. Each of small rectangles in the lattice pattern of the image sensor 108 conceptually represents one imaging element (or light-sensitive photo element).

The color filter array 110 has one of the R color filter, the G color filter, and the B color filter set corresponding to the position of each of the multiple imaging elements constituting the image sensor 108. In FIG. 2, the sparsely hatched rectangles, the densely hatched rectangles, and the non-hatched open rectangles respectively denote the R color filters, the B color filters, and the G color filters, respectively. In the arrangement of the R, G, and B color filters, the G color filters are positioned first to be diagonal to one another and form a checkerboard pattern. Namely the G color filters occupy half the area of the color filter array 110. The same numbers of the R color filters and the B color filters are then evenly arranged in the remaining half area of the color filter array 110. The resulting color filter array 110 of this arrangement shown in FIG. 2 is called the Bayer color filter array.

As mentioned above, the G color filters, the R color filters, and the B color filters are designed to allow transmission of only the G color light, transmission of only the R color light, and transmission of only the B color light, respectively. The image sensor 108 accordingly captures the image data of the mosaic arrangement by the function of the Bayer color filter array 110 located before the image sensor 108 as shown in FIG. 2. The image data of the mosaic arrangement is not processable in the same manner as ordinary image data and cannot directly express an image. The image processing apparatus 106 receives the image data of the mosaic arrangement (raw image data) and generates ordinary color image data having the settings of the R, G, and B components in each of the pixels.

### II. Example Demosaicking and Edge-Orientation Map Creation

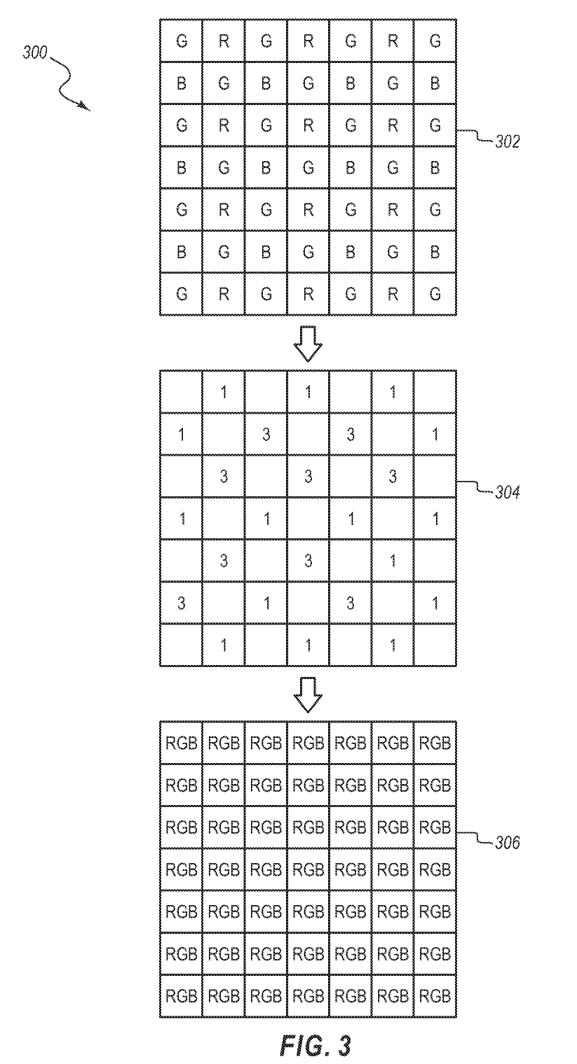

FIG. 3 is a flowchart of an example demosaicking and edge-orientation map creation method 300. As disclosed in FIG. 3, during the example method 300, raw image data 302 is used to create an edge-orientation map 304. The edge-orientation map 304 created in the example method 300 can be a binary (for two directions) or four-valued image (for four directions) with the spatial dimensions identical to that of the demosaicked image. For example, the edge-orientation map 304 can include pixels equal to ‘1’ indicating a dominant vertical direction and pixels equal to ‘3’ indicating a dominant horizontal direction. Alternatively, the edge-orientation map 304 created in the example method 300 can instead be another edge-orientation map with the pixels equal to ‘1’ indicating a dominant 135° direction (a primary diagonal) and with pixels equal to ‘3’ indicating a dominant 45° direction (a secondary diagonal). In another example, the edge-orientation map 304 can be a combination map that indicates vertical and horizontal directions as well as primary and secondary diagonal directions. Further, although the edge-orientation map 304 disclosed in FIG. 3 includes edge-orientation values corresponding R and B (chrominance) pixels of the raw image data 302, it is understood that the edge-orientation map 304 could instead include edge-orientation values corresponding G (luminance) pixels of the raw image data 302, or include edge-orientation values corresponding R, G, and B (luminance and chrominance) pixels of the raw image data 302. For example, in less intensive implementations of the method 300, edge-orientation values corresponding to only one of the chrominance or luminance pixels may be desired.

After the creation of the edge-orientation map 304, the edge-orientation map 304 is used in the method 300 to demosaick the raw image data 302 along edges identified in the edge-orientation map 304. The end result of the method 300 is a full-color demosaicked image 306. The full-color demosaicked image 306 may be an image x with pixels x_{(r,s)}=[x_{(r,s)1},x_{(r,s)2},x_{(r,s)3}] where x_{(r,s)1}, x_{(r,s)2}, and x_{(r,s)3} denote the R, G, and B components, respectively. In the image x with the resolution of K₁×K₂ pixels, the term (r,s) denotes the spatial location; with r=1,2, . . . , K₁ and s=1,2, . . . , K₂ indicating the image row and column, respectively.

In one example implementation, the example demosaicking and edge-orientation map creation method 300 can be accomplished as described in U.S. patent application Ser. No. 12/192,714, titled “DEMOSAICKING SINGLE-SENSOR CAMERA RAW DATA,” filed on Aug. 15, 2008, which is incorporated herein by reference in its entirety.

### III. Example Upsampling Method

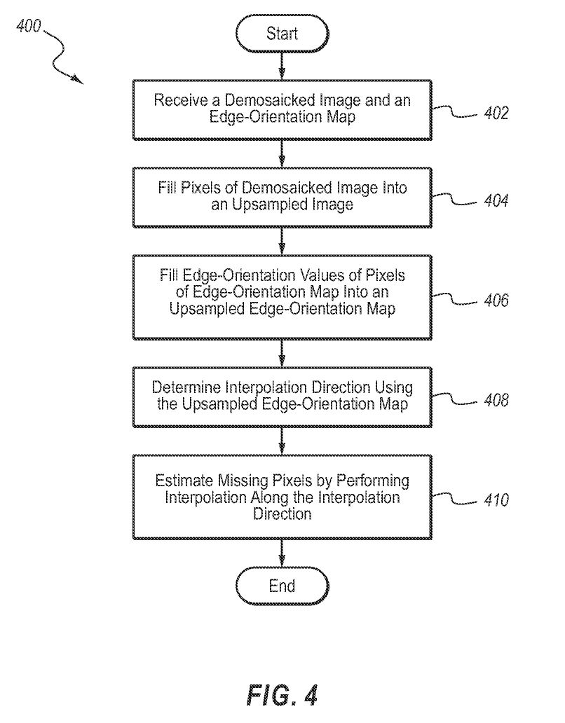

FIG. 4 is a flowchart of an example method 400 for automatic upsampling of a demosaicked image. The example method 400 for automatic upsampling transforms a demosaicked image into an upsampled image by an upsampling factor of λ. For the sake of simplicity an upsampling factor of λ=2 is considered herein. However, it is understood that extending the example method 400 to higher upsampling factors is straightforward and contemplated.

First, at 402, a demosaicked image and an edge-orientation map that was created during the creation of the demosaicked image are received. Next, at 404, pixels of the demosaicked image are filled into an upsampled image. Then, at 406, edge-orientation values of pixels of the edge-orientation map are filled into an upsampled edge-orientation map. Next, at 408, an interpolation direction is determined for each pixel in which upsampling of the demosaicked image should be performed using the upsampled edge-orientation map. Finally, at 410, missing pixels in the upsampled image are estimated by performing interpolation along the interpolation direction determined at act 408 using available pixels surrounding each missing pixel location.

It is noted that the example method 400 for automatic upsampling of a demosaicked image transforms electronic data that represents a physical and tangible object. In particular, the example method 400 transforms an electronic data representation of a demosaicked image that represents a real-world visual scene, such as a photograph of a person or a landscape, for example. During the example method 400, the data is transformed from a first state into a second state. In the first state, the data represents the real-world visual scene at a first baseline size. In the second state, the data represents the real-world visual scene at a second size represented by a higher number of pixels.

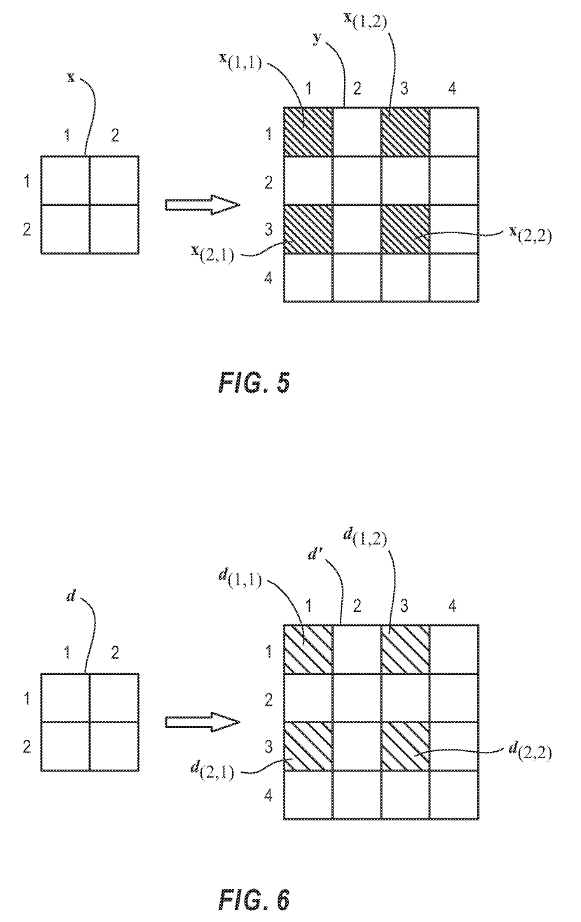

An example implementation of the example method 400 of FIG. 4 will now be disclosed in connection with FIGS. 3-7. With reference first to FIG. 3, at 402, a demosaicked image 306 and an edge-orientation map 304 are received, such as the demosaicked image x and the edge-orientation map d disclosed in FIG. 5. The edge-orientation map d was created during the creation of the demosaicked image x as part of the demosaicking process.

With reference now to FIG. 5, at 404, pixels of the demosaicked image are filled into an upsampled image. For example, as disclosed in FIG. 5, upsampling the demosaicked image x with an integer factor λ produces an upsampled image y with λK₁×λK₂ pixels y_{(m,n)}=[y_{(m,n)1},y_{(m,n)2},y_{(m,n)3}], for m=1,2, . . . , λK₁ and n=1,2, . . . , λK₂. The demosaicked pixels x_{(r,s)} are filled into the upsampled image as follows:

y_{(λ(r-1)+1,λ(s-1)+1)}=x_{(r,s)} (1)

For the upsampling factor λ=2, the act 404 can be described as follows:

y_{(2(r-1)+1,2(s-1)+1)}=x_{(r,s)} (2)

As disclosed in FIG. 5, the densely hatched rectangles of the upsampled image y represent the pixels of the demosaicked image x that are filled into the upsampled image y according to Equation (2). For example, x_{(1,1)} is filled into y_{(1,1)}, x_{(2,1)} is filled into y_{(3,1)}, x_{(1,2)} is filled into y_{(1,3)}, and x_{(2,2)} is filled into y_{(3,3)}.

With reference now to FIG. 6, at 406, edge-orientation values of pixels of the edge-orientation map are filled into an upsampled edge-orientation map. For example, as disclosed in FIG. 6, the edge-orientation values d_{(r,s)} of the edge-orientation map d may be filled into an upsampled edge-orientation map d′ as follows:

d′_{(λ(r-1)+1,λ(s-1)+1)}=d_{(r,s)} (3)

For the upsampling factor λ=2, the act 406 can be described as follows:

d′_{(2(r-1)+1,2(s-1)+1)}=d_{(r,s)} (4)

As disclosed in FIG. 6, the sparsely hatched rectangles of the upsampled edge-orientation map d′ represent the edge-orientation values of the edge-orientation map d that are filled into the upsampled edge-orientation map d′ according to Equation (4). For example, d_{(1,1)} is filled into d′_{(1,1)}, d_{(2,1)} is filled into d′_{(3,1)}, d_{(1,2)} is filled into d′_{(1,3)}, and d_{(2,2)} is filled into d′_{(3,3)}. In this example, the edge-orientation map d includes pixels d_{(r,s)}=1 indicating a dominant vertical direction and d_{(r,s)}=3 indicating a dominant horizontal direction.

Following the acts 404 and 406, the pixels to be interpolated in the upsampled image y are located in the (2(r−1)+1,2s), (2r,2(s−1)+1), and (2r,2s) locations which correspond in the upsampled image coordinate system to (odd m, even n), (even m, odd n), and (even m, even n), respectively. Each (odd m, even n) location is surrounded by two demosaicked pixels y_{(m,n-1)} and y_{(m,n+1)} available in the horizontal directions whereas each (even m, odd s) location is surrounded by two demosaicked pixels y_{(m-1,n)} and y_{(m+1,n)} available in the vertical direction.

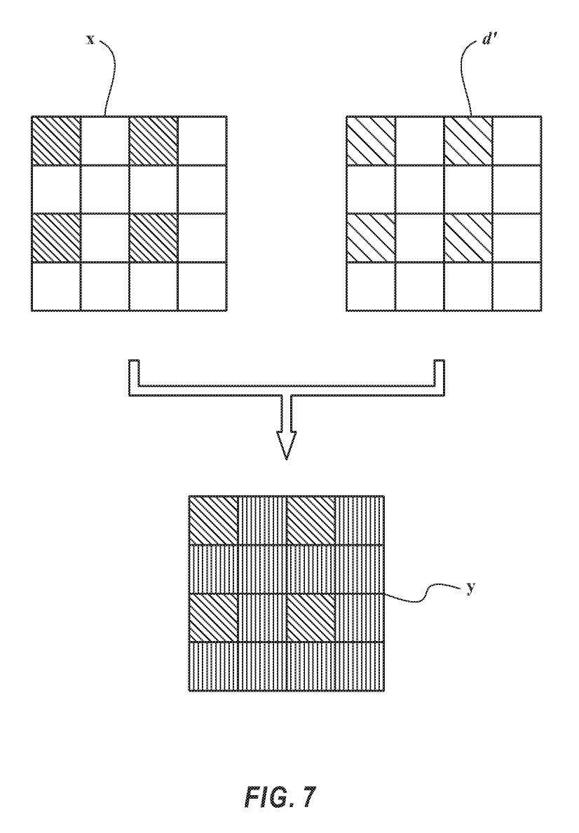

With reference now to FIG. 7, at 408, an interpolation direction is determined for each pixel in which upsampling of the demosaicked image should be performed using the upsampled edge-orientation map and, at 410, missing pixels in the upsampled image are estimated by performing interpolation along the interpolation direction determined at act 408 using available pixels surrounding each missing pixel location. As disclosed in FIG. 7, the acts 408 and 410 result in the densely vertically-hatched rectangles of the upsampled image y being filled in using the upsampled edge-orientation map d′ and using available pixels surrounding each missing pixel location. For example, the color components y_{(m,n)k}, for k=1,2,3 of the missing pixels y_{(m,n)} under consideration can be obtained in (odd m, even n) locations as follows:

$$y ( m , n ) k = \{ \begin{matrix}\frac{( {y}_{( m , n - 1 ) k} + {y}_{( m , n + 1 ) k} )}{2} & for {D}_{H} > 4 \\ \frac{( {w}_{1} {y}_{( m , n - 1 ) k} + {w}_{2} {y}_{( m , n + 1 ) k} )}{( {w}_{1} + {w}_{2} )} & for {D}_{H} \leq 4\end{matrix} \qquad ( 5 )$$

and in (even m, odd n) locations as follows:

$${y}_{( m , n ) k} = \{ \begin{matrix}\frac{( {y}_{( m - 1 , n ) k} + {y}_{( m + 1 , n ) k} )}{2} & for {D}_{V} \leq 4 \\ \frac{( {w}_{1} {y}_{( m - 1 , n ) k} + {w}_{2} {y}_{( m + 1 , n ) k} )}{( {w}_{1} + {w}_{2} )} & for {D}_{V} > 4\end{matrix} \\ where {D}_{H} = {d}_{( m , n - 1 )}^{′} + {d}_{( m , n + 1 )}^{′} and {D}_{V} = {d}_{( m - 1 , n )}^{′} + {d}_{( m + 1 , n )}^{′} . \qquad ( 6 )$$

In Equation (5), D_{H}>4 indicates that y_{(m,n)k} should be interpolated horizontally by averaging y_{(m,n-1)k} and y_{(m,n+1)k} from the horizontal direction. On the other hand, D_{H}≦4 indicates that there is a vertical edge and that the interpolation should be performed using available pixels located in the vertical direction. However, since (odd m, even n) is not surrounded by the demosaicked pixels in the vertical direction, it should be obtained using a weighted average of the available samples y_{(m,n-1)k} and y_{(m,n+1)k} from the horizontal direction. The operation is controlled using nonnegative weights w₁ and w₂ which express the spatial importance of the locations of the available pixels with respect to the location under consideration (m,n) and the demosaicked pixel location (r,s) which corresponds to a λ×λ block in the upsampled image. Thus, w₁ and w₂ in Equation should be constrained as w₁>w₂ because for λ=2 the location (m,n−1) belongs to the block corresponding to the (r,s) location in the demosaicked image. In practice, good results are usually produced with w₁=7 and w₂=1 which are easy to implement; however, cost-effective implementations can also use w₁=1 and w₂=0 or other configurations with a major contribution of w₁.

In Equation (6), when interpolating the missing pixels in (even m, odd n) locations, Dᵥ≦4 indicates that y_{(m,n)k} should be interpolated along the vertical edge using the average of two vertical neighbors y_{(m-1,n)k} and y_{(m+1,n)k}. For Dᵥ>4, interpolation should be performed in the horizontal direction; however, since (even m, odd n) is not surrounded by two demosaicked pixels in the horizontal direction, it should be estimated by weighting the contribution of y_{(m-1,n)k} and y_{(m+1,n)k} via w₁ and w₂, by following the rationale behind the vertical interpolation step in Equation (2). Note that Equation (2) and Equation (3) should use the same setting of w₁ and w₂.

Since each (even m, even n) location is surrounded by four demosaicked pixels y_{(m-1,n-1)}, y_{(m-1,n+1)}, y_{(m+1,n-1)}, and y_{(m+1,n+1)} located in the diagonal directions and none demosaicked pixels located in the vertical and horizontal directions, it cannot be interpolated directly. However, after the processing step described in Equation (5) is completed in all (odd m, even n) locations and Equation (6) in all (even m, odd n) locations, each (even m, even n) location becomes surrounded by two interpolated pixels located in the vertical directions and two interpolated pixels located in the horizontal direction. Therefore, interpolation in (even m, even n) locations can now be performed as follows:

$${y}_{( m , n ) k} = \{ \begin{matrix}\frac{( {y}_{( m , n - 1 ) k} + {y}_{( m , n + 1 ) k} )}{2} & for {D}_{D} > 8 \\ \frac{( {y}_{( m - 1 , n ) k} + {y}_{( m + 1 , n ) k} )}{2} & for {D}_{D} \leq 8\end{matrix} \qquad ( 7 )$$

where D_{D}=d′_{(m-1,n-1)}+d′_{(m-1,n+1)}+d′_{(m+1,n-1)}+d′_{(m+1,n+1)}. The satisfied condition D_{D}>8 dictates that the interpolation operation should be performed in the horizontal direction, whereas D_{D}≦8 suggests to interpolate along the vertical direction.

Another example implementation of acts 408 and 410 will now be described that uses the edge-orientation map b and a corresponding upsampled edge-orientation map b′. In this example, the edge-orientation map b includes pixels b_{(r,s)}=1 a dominant 135° direction (a primary diagonal) and b_{(r,s)}=3 indicating a dominant 45° direction (a secondary diagonal). As with the edge-orientation map d, the edge-orientation values b_{(r,s)} of the edge-orientation map b may be filled into an upsampled edge-orientation map b′as follows:

b′_{(λ(r-1)+1,λ(s-1)+1)}=b_{(r,s)} (8)

To interpolate along diagonal edges in the demosaicked image, the color components y_{(m,n)k}, for k=1,2,3, of the missing pixel y_{(m,n)} under consideration should be obtained in (odd m, even n) locations as follows:

$${y}_{( m , n ) k} = \{ \begin{matrix}\frac{( {w}_{3} {y}_{( m , n + 1 ) k} + {w}_{4} {y}_{( m , n - 1 ) k} + {w}_{5} {y}_{( m + 2 , n - 1 ) k} )}{( {w}_{3} + {w}_{4} + {w}_{5} )} & for {B}_{H} > 4 \\ \frac{( {w}_{3} {y}_{( m , n - 1 ) k} + {w}_{4} {y}_{( m , n + 1 ) k} + {w}_{5} {y}_{( m + 2 , n + 1 ) k} )}{( {w}_{3} + {w}_{4} + {w}_{5} )} & for {B}_{H} \leq 4\end{matrix} \qquad ( 9 )$$

and in (even m, odd n) locations as follows:

$${y}_{( m , n ) k} = \{ \begin{matrix}\frac{( {w}_{3} {y}_{( m + 1 , n ) k} + {w}_{4} {y}_{( m - 1 , n ) k} + {w}_{5} {y}_{( m - 1 , n + 2 ) k} )}{( {w}_{3} + {w}_{4} + {w}_{5} )} & for {B}_{V} > 4 \\ \frac{( {w}_{3} {y}_{( m - 1 , n ) k} + {w}_{4} {y}_{( m + 1 , n ) k} + {w}_{5} {y}_{( m + 1 , n + 2 ) k} )}{( {w}_{3} + {w}_{4} + {w}_{5} )} & for {B}_{V} \leq 4\end{matrix} \\ where {B}_{H} = {b}_{( m , n - 1 )}^{′} + {b}_{( m , n + 1 )}^{′} and {B}_{V} = {b}_{( m - 1 , n )}^{′} + {b}_{( m + 1 , n )}^{′} . \qquad ( 10 )$$

In Equation (9) and Equation (10), B_{H}>4 or B_{V}>4 suggest to interpolate along the 45° diagonal whereas B_{H}≦4 or B_{H}≦4 indicate that the interpolation process should be directed along the 135° diagonal. To reflect the spatial distance of the locations with the available demosaicked pixels to the location under consideration, the weights w₃, w₄, and w₅ should be constrained as w₃=w₄ and w₃>w₅. For example, both good performance and efficient implementation can be obtained via w₃=w₄=6 and w₅=4.

Interpolating the pixels in (even m, even n) locations is straightforward because each location under consideration is surrounded by diagonally located demosaicked pixels y_{(m-1,n-1)}, y_{(m-1,n+1)}, y_{(m+1,n-1)}, and y_{(m+1,n+1)}. Therefore, the missing pixels in (even m, even n) locations can be obtained as follows:

$${y}_{( m , n ) k} = \{ \begin{matrix}\frac{( {y}_{( m - 1 , n + 1 ) k} + {y}_{( m + 1 , n - 1 ) k} )}{2} & for {B}_{D} > 8 \\ \frac{( {y}_{( m - 1 , n - 1 ) k} + {y}_{( m + 1 , n + 1 ) k} )}{2} & for {B}_{D} \leq 8\end{matrix} \\ where {B}_{D} = {b}_{( m - 1 , n - 1 )}^{′} + {b}_{( m - 1 , n + 1 )}^{′} + {b}_{( m + 1 , n - 1 )}^{′} + {b}_{( m + 1 , n + 1 )}^{′} . \qquad ( 11 )$$

The example method 400 thus operates on a demosaicked image using an edge-orientation map created for the purpose of demosaicking. For the upsampling factor λ=2 and the edge orientation map indicating either horizontal or vertical interpolation directions, the upsampled demosaicked image is obtained by filling the demosaicked full-color data into the upsampled image using Equation (1) for all pixel locations in the demosaicked image. Since in the upsampled image the demosaicked pixels are located in (odd m, odd n) locations, Equation (5) and Equation (6) are used, respectively, to interpolate the missing pixels in all (odd m, even n) and (even m, odd n) locations. The example method 400 completes by performing Equation (7) in all (even m, even n) locations. Alternatively, if a diagonal edge-orientation map is used, then the example method 400 can interpolate along the diagonal edges using Equation (9) for (odd m, even n), Equation (10) for (even m, odd n), and Equation (11) for (even m, even n).

It is also noted that the example method 400 allows using a single edge-orientation map with four or more edge directions. The use of such a four-edge-direction edge-orientation map enables the combination of Equations (5) and (9) for (odd m, even n), Equations (6) and (10) for (even m, odd n), and Equations (7) and (11) for (even m, even n) and modifying the switching conditions in these combined equations.

Thus, the example method 400 transforms a demosaicked full-color image into its upsampled variant. Using the same edge-orientation map(s) to guide consistently the interpolation process in the demosaicking and upsampling methods allows high-quality upsampled images to be produced while making the example method 400 computationally efficient. Sharing the edge-orientation map(s) in both demosaicking and upsampling processes and performing linear interpolation operations allows effective implementation of the example method 400 directly in single-sensor cameras and on host devices such as personal computers and printers.

### IV. Example Downsampling Method

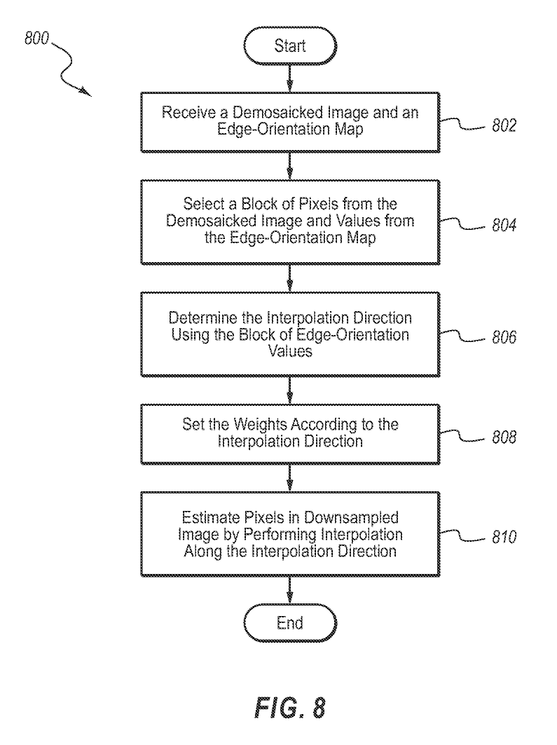

FIG. 8 is a flowchart of an example method 800 for automatic downsampling of a demosaicked image. The example method 800 for automatic downsampling transforms a demosaicked image into a downsampled image by a downsampling factor of θ. For the sake of simplicity a downsampling factor of 74 =2 is considered herein. However, it is understood that extending the example method 800 to higher downsampling factors is straightforward and contemplated.

First, at 802, a demosaicked image and an edge-orientation map that was created during the creation of the demosaicked image are received. Next, at 804, a block of demosaicked pixels from the demosaicked image and a corresponding block of edge-orientation values from the edge-orientation map are selected based on the location of each pixel under consideration in a downsampled image and a downsampling factor. Then, at 806, the interpolation direction in which downsampling of the demosaicked image should be performed is determined using the value of the selected block of edge-orientation values. Next, at 808, weights associated with the demosaicked pixels located inside the block of demosaicked pixels are set according to the interpolation direction determined in the act 806. Finally, pixels in the downsampled image are estimated by performing interpolation along the interpolation direction determined in the act 806 using demosaicked pixels located inside the block of demosaicked pixels and the weights associated with the demosaicked pixels located inside the block of demosaicked pixels.

It is noted that the example method 800 for automatic downsampling of a demosaicked image transforms electronic data that represents a physical and tangible object. In particular, the example method 800 transforms an electronic data representation of a demosaicked image that represents a real-world visual scene, such as a photograph of a person or a landscape, for example. During the example method 800, the data is transformed from a first state into a second state. In the first state, the data represents the real-world visual scene at a first baseline size. In the second state, the data represents the real-world visual scene at a second size represented by a lower number of pixels.

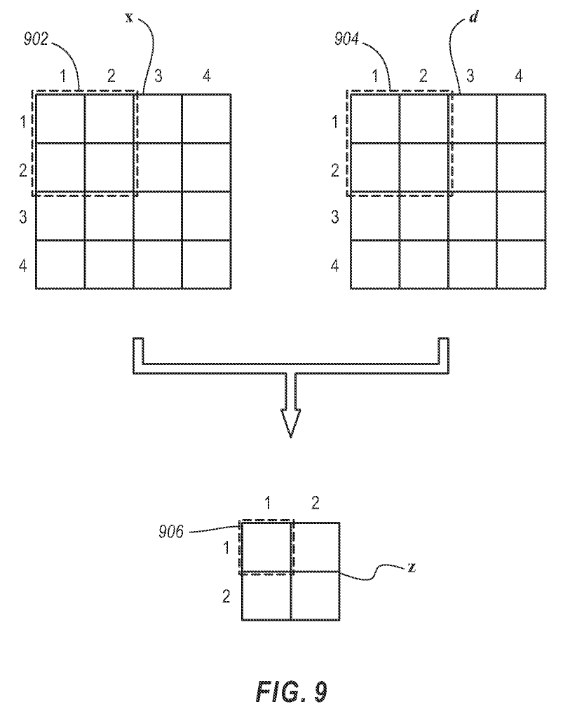

An example implementation of the example method 800 of FIG. 8 will now be disclosed in connection with FIGS. 3, 8, and 9. With reference first to FIG. 3, at 802, a demosaicked image 306 and an edge-orientation map 304 are received, such as the demosaicked image x and the edge-orientation map d disclosed in FIG. 9. The edge-orientation map d was created during the creation of the demosaicked image x as part of the demosaicking process.

With reference now to FIG. 9, at 804, a θ×θ block of demosaicked pixels from the demosaicked image x and a corresponding θ×θ block of edge-orientation values from the edge-orientation map d are selected based on the location of each pixel z_{(p,q)} under consideration in a downsampled image z and a downsampling factor θ. As disclosed in FIG. 9, a 2×2 block 902 of demosaicked pixels from the demosaicked image x and a corresponding 2×2 block 904 of edge-orientation values from the edge-orientation map d are selected based on the location of the pixel z_{(1,1)} under consideration 906 in the downsampled image z and the downsampling factor θ=2. In this example implementation, (p,q) denotes the spatial location in the image z, with K₁/θ×K₂/θ pixels, where p=1,2, . . . , K₁/θ and q=1,2, . . . , K₂/θ denote the image row and image column, respectively.

Then, at 806, the interpolation direction in which downsampling of the demosaicked image x should be performed is determined using the value of the selected 2×2 block 904 of edge-orientation values. Next, at 808, the weights associated with the demosaicked pixels located inside the 2×2 block 904 of demosaicked pixels are set according to the interpolation direction determined in the act 806. Finally, pixels in the downsampled image z are estimated by performing interpolation along the interpolation direction determined in the act 806 using demosaicked pixels located inside the 2×2 block 904 of demosaicked pixels and the weights associated with the demosaicked pixels located inside the 2×2 block 904 of demosaicked pixels.

In this example implementation, on the pixel level, the method 800 transforms a θ×θ block of pixels x_{(i,j)}, for (p−1)θ<i≦pθ and (q−1)θ<j≦qθ, to a single pixel z_{(p,q)}. When performing downsampling operations in a component-wise manner, the process can be described as follows:

$${z}_{( p , q ) k} = \frac{1}{W} {\sum }_{i = ( p - 1 ) θ + 1}^{p θ} {\sum }_{j = ( q - 1 ) θ + 1}^{q θ} {w}_{( i , j )} {x}_{( i , j ) k} \\ for k = 1 , 2 , 3 \qquad ( 12 )$$

where z_{(p,q)}=[z_{(p,q)1},z_{(p,q)2},z_{(p,q)3] denotes the color pixel in the downsampled image, w}_{(i,j)} denotes the weight associated with the (i,j) location inside the block and W is the weight normalization factor given by:

$$W = {\sum }_{i = ( p - 1 ) θ + 1}^{p θ} {\sum }_{j = ( q - 1 ) θ + 1}^{q θ} {w}_{( i , j )} \qquad ( 13 )$$

In order to avoid the blur effects, the weights in Equation (12) should be set in a way that downsampling is performed along the edges present in the captured image. Since the determination of the orientation of edges is essential for demosaicking performance and powerful edge orientation detectors are computationally complex, using the same edge orientation map in both demosaicking and downsampling is of paramount importance in cost effective imaging systems to make these two image processing operations faster and easier to implement. In addition to computational efficiency issues, image quality is another criterion which has to be considered when setting the weights in Equation (12). Naturally looking images can be produced if both demosaicking and downsampling operations are directed along edges consistently; that is, using the same edge orientation map. The visual quality of the output, downsampled demosaicked image thus depends on the accuracy of edge orientation detection.

The θ=2 setting implies downsampling operations performed in 2×2 blocks by using four weights w_{(2(p-1)+1,2(q-1)+1)}, w_{(2(p-1)+1,2q)}, w_{(2p,2(q-1)+1)}, w_{(2p,2q)}. The setting of the weight varies depending on the direction on the image lattice in which the downsampling interpolation operation should be performed. Thus, this example implementation uses four different set of weights (one set for each of vertical, horizontal, and two diagonal directions). Namely, horizontal and vertical edges are preserved during downsampling using the weights defined as follows:

w_{(2(p-1)+1,2(q-1)+1)}=w_{(2(p-1)+1,2q)}=1 and w_{(2p,2(q-1)+1)}=w_{(2p,2q)}=0 for D>8 w_{(2(p-1)+1,2(q-1)+1)}=w_{(2p,2(q-1)+1)}=1 and w_{(2(p-1)+1,2q)}=w_{(2p,2q)}=0 for D≦8 (14)

where D=d_{(2(p-1)+1,2(q-1)+1)}+d_{(2(p-1)+1,2q)}+d_{(2p,2(q-1)+1)}+d_{(2p,2q)} is an aggregated edge-orientation value indicating for D>8 that interpolation should be performed in the horizontal direction and D≦8 that interpolation should be performed in the vertical direction, given an edge-orientation map d with pixels equal to ‘1’ indicating a dominant vertical direction and pixels equal to ‘3’ indicating a dominant horizontal direction.

Alternatively, diagonal edges may be preserved during downsampling when the weights are set to:

w_{(2p,2(q-1)+1)}=w_{(2(p-1)+1,2q)}=1 and w_{(2(p-1)+1,2(q-1)+1)}=w_{(2p,2q)}=0 for B>8 w_{(2(p-1)+1,2(q-1)+1)}=w_{(2p,2q)}=1 and w_{(2p,2(q-1)+1)}=w_{(2(p-1)+1,2,q)}=0 for B≦8 (15)

where B=b_{(2(p-1)+1,2(q-1)+1)}+b_{(2(p-1)+1,2q)}+b_{(2p,2(q-1)+1)}+b_{(2p,2q)}. The value B>8 implies interpolation in the secondary diagonal direction whereas B≦8 suggests to interpolate in the primary diagonal direction, given an edge-orientation map b with pixels equal to ‘1’ indicating a dominant 135° direction (a primary diagonal) and pixels equal to ‘3’ indicating a dominant 45° direction (a secondary diagonal). Note that if certain smoothing of downsampled images is desired, then zero weights in Equation (14) and Equation (15) may be set to nonzero values ranging from about 0 to about 1. It should be understood that the weights can be set as integers in a way which allows cost-effective calculations in Equation (12).

The downsampled image z is obtained by repeating Equation (12) in each pixel location of the downsampled image z; that is, for p=1,2, . . . , K₁/θ and q=1,2, . . . , K₂/θ. For the upsampling factor θ=2 and the edge orientation map d indicating the horizontal and vertical interpolation directions in which demosaicking of the raw sensor data was performed, Equation (12) may use the weights which follow the rationale behind Equation (14). If the diagonal edge-orientation map b is available, then Equation (12) may use the weights which follow the rationale behind Equation (15) instead of, or in addition to, Equation (14) in all pixel locations where diagonal edges were detected.

The present invention may be embodied in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for automatic upsampling of a demosaicked image, the method comprising the following acts:
i) receiving a demosaicked image and an edge-orientation map that was created during the creation of the demosaicked image;
ii) filling pixels of the demosaicked image into an upsampled image;
iii) filling edge-orientation values of pixels of the edge-orientation map into an upsampled edge-orientation map;
iv) determining an interpolation direction for each pixel in which upsampling of the demosaicked image should be performed using the upsampled edge-orientation map; and
v) estimating missing pixels in the upsampled image by performing interpolation along the interpolation direction determined at act iv) using available pixels surrounding each missing pixel location.

2. The method as recited in claim 1, wherein the act ii) comprises filling the pixels of the demosaicked image x into the upsampled image y according to the following equation:
y_{(λ(r-1)+1,λ(s-1)+1)}=x_{(r,s)}
where:
x is the demosaicked image with pixels x_{(r,s)}=[x_{(r,s)1},x_{(r,s)2},x_{(r,s)3}] with x_{(r,s)k} indicating an R (k=1), G (k=2), or B (k=3) component,
r=1,2, . . . , K₁ and s=1,2, . . . , K₂ denote, respectively, a row and a column of the demosaicked image x with K₁ rows and K₂ columns,
λ is an integer upsampling factor, with λ>1, and
y is the upsampled image with λK₁×λK₂ pixels y_{(m,n)}=[y_{(m,n)1},y_{(m,n)2},y_{(m,n)3}] with y_{(m,n)k} indicating an R (k=1) , G (k=2), or B (k=3) component, for m=1,2, . . . , λK₁ and n=1,2, . . . , λK₂.

3. The method as recited in claim 2, wherein the edge-orientation map d includes pixels d_{(r,s)} and is a two-valued edge-orientation map with d_{(r,s)}=1 indicating a dominant vertical direction and d_{(r,s)}=3 indicating a dominant horizontal direction.

4. The method as recited in claim 3, wherein the acts iv) and v) are performed according to the following equations:
$${y}_{( m , n ) k} = \{ \begin{matrix}\frac{( {y}_{( m , n - 1 ) k} + {y}_{( m , n + 1 ) k} )}{2} & for {D}_{H} > 4 \\ \frac{( {w}_{1} {y}_{( m , n - 1 ) k} + {w}_{2} {y}_{( m , n + 1 ) k} )}{( {w}_{1} + {w}_{2} )} & for {D}_{H} \leq 4\end{matrix} \\ for ( odd m , even n ) , \\ {y}_{( m , n ) k} = \{ \begin{matrix}\frac{( {y}_{( m - 1 , n ) k} + {y}_{( m + 1 , n ) k} )}{2} & for {D}_{V} \leq 4 \\ \frac{( {w}_{1} {y}_{( m - 1 , n ) k} + {w}_{2} {y}_{( m + 1 , n ) k} )}{( {w}_{1} + {w}_{2} )} & for {D}_{V} > 4\end{matrix} \\ for ( even m , odd n ) , and \\ {y}_{( m , n ) k} = \{ \begin{matrix}\frac{( {y}_{( m , n - 1 ) k} + {y}_{( m , n + 1 ) k} )}{2} & for {D}_{D} > 8 \\ \frac{( {y}_{( m - 1 , n ) k} + {y}_{( m + 1 , n ) k} )}{2} & for {D}_{D} \leq 8\end{matrix} \\ for ( even m , even n ) ,$$
where:
D_{H}=d′_{(m,n-1)}+d′_{(m,n+1)},
D_{V}=d′_{(m-1,n)}+d′_{(m+1,n)},
D_{D}=d′_{(m-1,n-1)}+d′_{(m-1,n+1)}+d′_{(m+1,n-1)}+d′_{(m+1,n+1)},
d′ is the upsampled edge-orientation map with d′_{(λ(r-1)+1,λ(s-1)+1)}=d_{(r,s)}, and
w₁ and w₂ are nonnegative weights with w₁>w₂.

5. The method as recited in claim 2, wherein the edge-orientation map b includes pixels b_{(r,s)} and is a two-valued edge-orientation map with b_{(r,s)}=1 indicating a dominant 135° direction and b_{(r,s)}=3 indicating a dominant 45° direction.

6. The method as recited in claim 5, wherein the acts iv) and v) are performed according to the following equations:
$${y}_{( m , n ) k} = \{ \begin{matrix}\frac{( {w}_{3} {y}_{( m , n + 1 ) k} + {w}_{4} {y}_{( m , n - 1 ) k} + {w}_{5} {y}_{( m + 2 , n - 1 ) k} )}{( {w}_{3} + {w}_{4} + {w}_{5} )} & for {B}_{H} > 4 \\ \frac{( {w}_{3} {y}_{( m , n + 1 ) k} + {w}_{4} {y}_{( m , n + 1 ) k} + {w}_{5} {y}_{( m + 2 , n + 1 ) k} )}{( {w}_{3} + {w}_{4} + {w}_{5} )} & for {B}_{H} \leq 4\end{matrix} \\ for ( odd m , even n ) , \\ {y}_{( m , n ) k} = \{ \begin{matrix}\frac{( {w}_{3} {y}_{( m + 1 , n ) k} + {w}_{4} {y}_{( m - 1 , n ) k} + {w}_{5} {y}_{( m - 1 , n + 2 ) k} )}{( {w}_{3} + {w}_{4} + {w}_{5} )} & for {B}_{V} > 4 \\ \frac{( {w}_{3} {y}_{( m - 1 , n ) k} + {w}_{4} {y}_{( m + 1 , n ) k} + {w}_{5} {y}_{( m + 1 , n + 2 ) k} )}{( {w}_{3} + {w}_{4} + {w}_{5} )} & for {B}_{V} \leq 4\end{matrix} \\ for ( even m , odd n ) , and \\ {y}_{( m , n ) k} = \{ \begin{matrix}\frac{( {y}_{( m - 1 , n + 1 ) k} + {y}_{( m + 1 , n - 1 ) k} )}{2} & for {B}_{D} > 8 \\ \frac{( {y}_{( m - 1 , n - 1 ) k} + {y}_{( m + 1 , n + 1 ) k} )}{2} & for {B}_{D} \leq 8\end{matrix} \\ for ( even m , even n ) ,$$
where:
B_{H}=b′_{(m,n-1)}+b′_{(m,n+1)},
B_{V}=b′_{(m-1,n)}+b′_{(m+1,n)},
B_{D}=b′_{(m-1,n-1)}+b′_{(m-1,n+1)}+b′_{(m+1,n-1)}+b′_{(m+1,n+1)},
b′ is the upsampled edge-orientation map with b′_{(λ(r-1)+1,λ(s-1)+1)}=b_{(r,s)}, and
w₃, w₄, and w₅ are nonnegative weights with w₃=w₄ and w₃>w₅.

7. A method for automatic downsampling of a demosaicked image, the method comprising the following acts:
i) receiving a demosaicked image and an edge-orientation map that was created during the creation of the demosaicked image;
ii) selecting a block of demosaicked pixels from the demosaicked image and a corresponding block of edge-orientation values from the edge-orientation map based on the location of each pixel under consideration in a downsampled image and a downsampling factor;
iii) determining the interpolation direction in which downsampling of the demosaicked image should be performed using the value of the selected block of edge-orientation values;
iv) setting weights associated with the demosaicked pixels located inside the block of demosaicked pixels according to the interpolation direction determined in the act iii); and
v) estimating pixels in the downsampled image by performing interpolation along the interpolation direction determined in the act iii) using demosaicked pixels located inside the block of demosaicked pixels and the weights associated with the demosaicked pixels located inside the block of demosaicked pixels.

8. The method as recited in claim 7, wherein the act v) comprises estimating pixels in the downsampled image z by performing interpolation along the interpolation direction determined in the act iii) using demosaicked pixels located inside the θ×θ block of demosaicked pixels x_{(i,j)} defined by (p−1)θ<i≦pθ and (q−1)θ<j≦qθ and the weights w_{(i,j)} associated with the demosaicked pixels located inside the θ×θ block of demosaicked pixels according to the following equation:
$${z}_{( p , q ) k} = \frac{1}{W} {\sum }_{i = ( p - 1 ) θ + 1}^{p θ} {\sum }_{j = ( q - 1 ) θ + 1}^{q θ} {w}_{( i , j )} {x}_{( i , j ) k}$$
$$for k = 1 , 2 , and 3 ,$$
where:
x is the demosaicked image with pixels x_{(r,s)}=[x_{(r,s)1},x_{(r,s)2},x_{(r,s)3}] with x_{(r,s)k} indicating an R (k=1), G (k=2), or B (k=3) component,
r=1,2, . . . , K₁ and s=1,2, . . . , K₂ denote, respectively, a row and a column of the demosaicked image x with K₁ rows and K₂ columns,
θ is the downsampling factor, with θ>1,
z is the downsampled image with K₁/θ×K₂/θ pixels z_{(p,q)}=[z_{(p,q)1},z_{(p,q)2},z_{(p,q)3}] with z_{(p,q)k} indicating an R (k=1) , G (k=2), or B (k=3) component, for p=1,2, . . . , K₁/θ and q=1,2, . . . , K₂/θ, and
W is a weight normalization factor given by:
$$W = {\sum }_{i = ( p - 1 ) θ + 1}^{p θ} {\sum }_{j = ( q - 1 ) θ + 1}^{q θ} {w}_{( i , j )} .$$

9. The method as recited in claim 8, wherein the edge-orientation map d includes pixels d_{(r,s)} and is a two-valued edge-orientation map with d_{(r,s)}=1 indicating a dominant vertical direction and d_{(r,s)}=3 indicating a dominant horizontal direction.

10. The method as recited in claim 9, wherein the downsampling factor θ=2 and the weights w_{(i,j)} associated with the demosaicked pixels located inside the 2×2 block of demosaicked pixels x_{(i,j)} are determined according to the following equations:
w_{(2(p-1)+1,2(q-1)+1)}=w_{(2(p-1)+1,2q)}; w_{(2p,2(q-1)+1)}=w_{(2p,2q)}; w_{(2(p-1)+1,2q)}w_{(2p,2(q-1)+1)} for D>8
w_{(2(p-1)+1,2(q-1)+1)}=w_{(2p,2(q-1)+1)}; w_{(2(p-1)+1,2q)}=w_{(2p,2q)}; w_{(2p,2(q-1)+1)}>w_{(2(p-1)+1,2q)} for D≦8
where:
D=d_{(2(p-1)+1,2(q-1)+1)}+d_{(2(p-1)+1,2q)+d}_{(2p,2(q-1)+1)}+d_{(2p,2q)} is an aggregated edge-orientation value,
D>8 indicates that interpolation should be performed in the horizontal direction; and
D≦8 indicates that interpolation should be performed in the vertical direction.

11. The method as recited in claim 8, wherein the edge-orientation map b includes pixels b_{(r,s)} and is a two-valued edge-orientation map with b_{(r,s)}=1 indicating a dominant 135° direction and b_{(r,s)}=3 indicating a dominant 45° direction.

12. The method as recited in claim 11, wherein the downsampling factor θ=2 and the weights w_{(i,j)} associated with the demosaicked pixels located inside the 2×2 block of demosaicked pixels x_{(i,j)} are determined according to the following equations:
w_{(2p,2(q-1)+1)}=w_{(2(p-1)+1,2q)}; w_{(2(p-1)+1,2(q-1)+1)}=w_{(2p,2q)}; w_{(2(p-1)+1,2q)}>w_{(2(p-1)+1,2(q-1)+1)} for B>8
w_{(2(p-1)+1,2(q-1)+1)}=w_{(2p,2q)}; w_{(2p,2(q-1)+1)}=w_{(2(p-1)+1,2q)}; w_{(2p,2q)}>w_{(2p,2(q-1)+1)} for B≦8
where:
B=b_{(2(p-1)+1,2(q-1)+1)}+b_{(2(p-1)+1,2q)}+b_{(2p,2(q-1)+1)}+b_{(2p,2q)} is an aggregated edge-orientation value,
B>8 indicates that interpolation should be performed in a dominant 135° diagonal direction; and
B≦8 indicates that interpolation should be performed in a dominant 45° diagonal direction.

13. One or more computer-readable media having computer-readable instructions thereon which, when executed by a processor, implement a method for automatic upsampling of a demosaicked image, the method comprising the acts of:
i) receiving a demosaicked image and an edge-orientation map that was created during the creation of the demosaicked image;
ii) filling pixels of the demosaicked image into an upsampled image;
iii) filling edge-orientation values of pixels of the edge-orientation map into an upsampled edge-orientation map;
iv) determining an interpolation direction for each pixel in which upsampling of the demosaicked image should be performed using the upsampled edge-orientation map; and
v) estimating missing pixels in the upsampled image by performing interpolation along the interpolation direction determined at act iv) using available pixels surrounding each missing pixel location.

14. The one or more computer-readable media as recited in claim 13, wherein the act ii) comprises filling the pixels of the demosaicked image x into the upsampled image y according to the following equation:
y_{(λ(r-1)+1,λ(s-1)+1)}=x_{(r,s)}
where:
x is the demosaicked image with pixels x_{(r,s)}=[x_{(r,s)1},x_{(r,s)2},x_{(r,s)3}] with x_{(r,s)k} indicating an R (k=1), G (k=2), or B (k=3) component,
r=1,2, . . . , K₁ and s=1,2, . . . , K₂ denote, respectively, a row and a column of the demosaicked image x with K₁ rows and K₂ columns,
λ is an integer upsampling factor, with λ>1, and
y is the upsampled image with λK₁×λK₂ pixels y_{(m,n)}=[y_{(m,n)1},y_{(m,n)2},y_{(m,n)3}] with y_{(m,n)k} indicating an R (k=1) , G (k=2), or B (k=3) component, for m=1,2, . . . , λK₁ and n=1,2, . . . , λK₂.

15. The one or more computer-readable media as recited in claim 14, wherein:
the edge-orientation map d includes pixels d_{(r,s)} and is a two-valued edge-orientation map with d_{(r,s)}=1 indicating a dominant vertical direction and
d_{(r,s)}=3 indicating a dominant horizontal direction; and
the acts iv) and v) are performed according to the following equations:
$${y}_{( m , n ) k} = \{ \begin{matrix}\frac{( {y}_{( m , n - 1 ) k} + {y}_{( m , n + 1 ) k} )}{2} & for {D}_{H} > 4 \\ \frac{( {w}_{1} {y}_{( m , n - 1 ) k} + {w}_{2} {y}_{( m , n + 1 ) k} )}{( {w}_{1} + {w}_{2} )} & for {D}_{H} \leq 4\end{matrix} \\ for ( odd m , even n ) , \\ {y}_{( m , n ) k} = \{ \begin{matrix}\frac{( {y}_{( m - 1 , n ) k} + {y}_{( m + 1 , n ) k} )}{2} & for {D}_{V} \leq 4 \\ \frac{( {w}_{1} {y}_{( m - 1 , n ) k} + {w}_{2} {y}_{( m + 1 , n ) k} )}{( {w}_{1} + {w}_{2} )} & for {D}_{V} > 4\end{matrix} \\ for ( even m , odd n ) , and \\ {y}_{( m , n ) k} = \{ \begin{matrix}\frac{( {y}_{( m , n - 1 ) k} + {y}_{( m , n + 1 ) k} )}{2} & for {D}_{D} > 8 \\ \frac{( {y}_{( m - 1 , n ) k} + {y}_{( m + 1 , n ) k} )}{2} & for {D}_{D} \leq 8\end{matrix} \\ for ( even m , even n ) ,$$
where:
D_{H}=d′_{(m,n-1)}+d′_{(m,n+1)},
D_{V}=d′_{(m-1,n)}+d′_{(m+1,n)},
D_{D}=d′_{(m-1,n-1)}+d′_{(m-1,n+1)}+d′_{(m+1,n-1)}+d′_{(m+1,n+1)},
d′ is the upsampled edge-orientation map with d′_{(λ(r-1)+1,λ(s-1)+1)}=d_{(r,s)}, and
w₁ and w₂ are nonnegative weights with w₁>w₂.

16. The one or more computer-readable media as recited in claim 14, wherein:
the edge-orientation map b includes pixels b_{(r,s)} and is a two-valued edge-orientation map with b_{(r,s)}=1 indicating a dominant 135° direction and b_{(r,s)}=3 indicating a dominant 45° direction; and
the acts iv) and v) are performed according to the following equations:
$${y}_{( m , n ) k} = \{ \begin{matrix}\frac{( {w}_{3} {y}_{( m , n + 1 ) k} + {w}_{4} {y}_{( m , n - 1 ) k} + {w}_{5} {y}_{( m + 2 , n - 1 ) k} )}{( {w}_{3} + {w}_{4} + {w}_{5} )} & for {B}_{H} > 4 \\ \frac{( {w}_{3} {y}_{( m , n - 1 ) k} + {w}_{4} {y}_{( m , n + 1 ) k} + {w}_{5} {y}_{( m + 2 , n + 1 ) k} )}{( {w}_{3} + {w}_{4} + {w}_{5} )} & for {B}_{H} \leq 4\end{matrix} \\ for ( odd m , even n ) , \\ {y}_{( m , n ) k} = \{ \begin{matrix}\frac{( {w}_{3} {y}_{( m + 1 , n ) k} + {w}_{4} {y}_{( m - 1 , n ) k} + {w}_{5} {y}_{( m - 1 , n + 2 ) k} )}{( {w}_{3} + {w}_{4} + {w}_{5} )} & for {B}_{V} > 4 \\ \frac{( {w}_{3} {y}_{( m - 1 , n ) k} + {w}_{4} {y}_{( m + 1 , n ) k} + {w}_{5} {y}_{( m + 1 , n + 2 ) k} )}{( {w}_{3} + {w}_{4} + {w}_{5} )} & for {B}_{V} \leq 4\end{matrix} \\ for ( even m , odd n ) , and \\ {y}_{( m , n ) k} = \{ \begin{matrix}\frac{( {y}_{( m - 1 , n + 1 ) k} + {y}_{( m + 1 , n - 1 ) k} )}{2} & for {B}_{D} > 8 \\ \frac{( {y}_{( m - 1 , n - 1 ) k} + {y}_{( m + 1 , n + 1 )} k )}{2} & for {B}_{D} \leq 8\end{matrix} \\ for ( even m , even n ) ,$$
where:
B_{H}=b′_{(m,n-1)}+b′_{(m,n+1)},
B_{V}=b′_{(m-1,n)}+b′_{(m+1,n)},
B_{D}=b′_{(m-1,n-1)}+b′_{(m-1,n+1)}+b′_{(m+1,n-1)}+b′_{(m+1,n+1)},
b′ is the upsampled edge-orientation map with b′_{(λ,(r-1)+1,λ(s-1)+1)}b_{(r,s)}, and
w₃, w₄, and w₅ are nonnegative weights with w₃=w₄ and w₃>w₅.

17. One or more computer-readable media having computer-readable instructions thereon which, when executed by a processor, implement a method for automatic downsampling of a demosaicked image, the method comprising the acts of:
i) receiving a demosaicked image and an edge-orientation map that was created during the creation of the demosaicked image;
ii) selecting a block of demosaicked pixels from the demosaicked image and a corresponding block of edge-orientation values from the edge-orientation map based on the location of each pixel under consideration in a downsampled image and a downsampling factor;
iii) determining the interpolation direction in which downsampling of the demosaicked image should be performed using the value of the selected block of edge-orientation values;
iv) setting weights associated with the demosaicked pixels located inside the block of demosaicked pixels according to the interpolation direction determined in the act iii); and
v) estimating pixels in the downsampled image by performing interpolation along the interpolation direction determined in the act iii) using demosaicked pixels located inside the block of demosaicked pixels and the weights associated with the demosaicked pixels located inside the block of demosaicked pixels.

18. The one or more computer-readable media as recited in claim 17, wherein the act v) comprises estimating pixels in the downsampled image z by performing interpolation along the interpolation direction determined in the act iii) using demosaicked pixels located inside the θ×θ block of demosaicked pixels x_{(i,j)} defined by (p−1)θ<i≦pθ and (q−1)θ<j≦qθ and the weights w_{(i,j)} associated with the demosaicked pixels located inside the θ×θ block of demosaicked pixels according to the following equation:
$${z}_{( p , q ) k} = \frac{1}{W} {\sum }_{i = ( p - 1 ) θ + 1}^{p θ} {\sum }_{j = ( q - 1 ) θ + 1}^{q θ} {w}_{( i , j )} {x}_{( i , j ) k}$$
$$for k = 1 , 2 , and 3 ,$$
where:
x is the demosaicked image with pixels x_{(r,s)}=[x_{(r,s)1},x_{(r,s)2},x_{(r,s)3}] with x_{(r,s)k} indicating an R (k=1), G (k=2), or B (k=3) component,
r=1,2, . . . , K₁ and s=1,2, . . . , K₂ denote, respectively, a row and a column of the demosaicked image x with K₁ rows and K₂ columns,
θ is the downsampling factor, with θ>1,
z is the downs amp led image with K₁/θ×K₂/θ pixels z_{(p,q)}=[z_{(p,q)1},z_{(p,q)2},z_{(p,q)3}] with z_{(p,q)k} indicating an R (k=1) , G (k=2), or B (k=3) component, for p=1,2, . . . , K₁/θ and q=1,2, . . . , K₂/θ, and
W is a weight normalization factor given by:
$$W = {\sum }_{i = ( p - 1 ) θ + 1}^{p θ} {\sum }_{j = ( q - 1 ) θ + 1}^{q θ} {w}_{( i , j )} .$$

19. The one or more computer-readable media as recited in claim 18, wherein:
the edge-orientation map d includes pixels d_{(r,s)} and is a two-valued edge-orientation map with d_{(r,s)}=1 indicating a dominant vertical direction and d_{(r,s)}=3 indicating a dominant horizontal direction; and
the downsampling factor θ=2 and the weights w_{(i,j)} associated with the demosaicked pixels located inside the 2×2 block of demosaicked pixels x_{(i,j)} are determined according to the following equations:
w_{(2(p-1)+1,2(q-1)+1)}=w_{(2(p-1)+1,2q)}; w_{(2p,2(q-1)+1)}=w_{(2p,2q)}; w_{(2(p-1)+1,2q)}>w_{(2p,2(q-1)+1)} for D>8
w_{(2(p-1)+1,2(q-1)+1)}=w_{(2p,2(q-1)+1)}; w_{(2(p-1)+1,2q)}=w_{(2p,2q)}; w_{(2p,2(q-1)+1)}>w_{(2(p-1)+1,2q)} for D≦8
where:
D=d_{(2(p-1)+1,2(q-1)+1)}+d_{(2(p-1)+1,2q)}+d_{(2p,2(q-1)+1)}+d_{(2p,2q)} is an aggregated edge-orientation value,
D>8 indicates that interpolation should be performed in the horizontal direction; and
D≦8 indicates that interpolation should be performed in the vertical direction.

20. The one or more computer-readable media as recited in claim 18, wherein:
the edge-orientation map b includes pixels b_{(r,s)} and is a two-valued edge-orientation map with b_{(r,s)}=1 indicating a dominant 135° direction and b_{(r,s)}=3 indicating a dominant 45° direction; and
the downsampling factor θ=2 and the weights w_{(i,j)} associated with the demosaicked pixels located inside the 2×2 block of demosaicked pixels x_{(i,j)} are determined according to the following equations:
w_{(2p,2(q-1)+1)}=w_{(2(p-1)+1,2q)}; w_{(2(p-1)+1,2(q-1)+1)}=w_{(2p,2q)}; w_{(2(p-1)+1,2q)}>w_{(2(p-1)+1,2(q-1)+1)} for B>8
w_{(2(p-1)+1,2(q-1)+1)}=w_{(2p,2q)}; w_{(2p,2(q-1)+1)}=w_{(2(p-1)+1,2q)}; w_{(2p,2q)}>w_{(2p,2(q-1)+1)} for B≦8
where:
B=b_{(2(p-1)+1,2(q-1)+1)}+b_{(2(p-1)+1,2q)}+b_{(2p,2(q-1)+1)}+b_{(2p,2q)} is an aggregated edge-orientation value,
B>8 indicates that interpolation should be performed in a dominant 135° diagonal direction; and
B≦8 indicates that interpolation should be performed in a dominant 45° diagonal direction.

21. An image processing apparatus comprising:
an electronic display; and
a processor in electronic communication with the electronic display; and
one or more computer-readable media in electronic communication with the processor, the one or more computer-readable media having computer-readable instructions thereon which, when executed by the processor, cause the processor to:
i) receive a demosaicked image and an edge-orientation map that was created during the creation of the demosaicked image;
ii) fill pixels of the demosaicked image into an upsampled image;
iii) fill edge-orientation values of pixels of the edge-orientation map into an upsampled edge-orientation map;
iv) determine an interpolation direction for each pixel in which upsampling of the demosaicked image should be performed using the upsampled edge-orientation map;
v) estimate missing pixels in the upsampled image by performing interpolation along the interpolation direction determined at iv) using available pixels surrounding each missing pixel location; and
vi) send the upsampled image to the electronic display for presentation thereon.

22. The image processing apparatus as recited in claim 21, wherein:
the image processing apparatus comprises a photo viewer;
the one or more computer-readable media comprises one or more of a RAM, a ROM, and a flash EEPROM; and
the electronic visual display comprises a liquid crystal display.

23. An image processing apparatus comprising:
an electronic display; and
a processor in electronic communication with the electronic display; and
one or more computer-readable media in electronic communication with the processor, the one or more computer-readable media having computer-readable instructions thereon which, when executed by the processor, cause the processor to:
i) receive a demosaicked image and an edge-orientation map that was created during the creation of the demosaicked image;
ii) select a block of demosaicked pixels from the demosaicked image and a corresponding block of edge-orientation values from the edge-orientation map based on the location of each pixel under consideration in a downsampled image and a downsampling factor;
iii) determine the interpolation direction in which downsampling of the demosaicked image should be performed using the value of the selected block of edge-orientation values;
iv) set weights associated with the demosaicked pixels located inside the block of demosaicked pixels according to the interpolation direction determined at iii);
v) estimate pixels in the downsampled image by performing interpolation along the interpolation direction determined at iii) using demosaicked pixels located inside the block of demosaicked pixels and the weights associated with the demosaicked pixels located inside the block of demosaicked pixels; and
vi) send the downsampled image to the electronic display for presentation thereon.

24. The image processing apparatus as recited in claim 23, wherein:
the image processing apparatus comprises a photo viewer;
the one or more computer-readable media comprises one or more of a RAM, a ROM, and a flash EEPROM; and
the electronic visual display comprises a liquid crystal display.

25. A method for automatically resizing a demosaicked image, the method comprising the following acts:
i) receiving a demosaicked image and an edge-orientation map that was created during the creation of the demosaicked image;
ii) resizing the edge-orientation map to create a resized edge-orientation map;
iii) determine the interpolation direction in which interpolation of the demosaicked image should be performed using the value of the selected block of edge-orientation values; and
iv) estimate pixels in a resized image by performing interpolation along the interpolation direction determined at iii).

26. The method as recited in claim 25, wherein the act iv) comprises the following acts:
iv.a) select a block of demosaicked pixels from the demosaicked image based on the location of each pixel under consideration in a resized image and a resizing factor;
iv.b) set weights associated with the demosaicked pixels located inside the block of demosaicked pixels according to the interpolation direction determined at iii); and
iv.c) estimate pixels in the resized image by performing interpolation along the interpolation direction determined at iii) using demosaicked pixels located inside the block of demosaicked pixels and the weights associated with the demosaicked pixels located inside the block of demosaicked pixels.
